(19) United States
(12) Patent Application Publication
(10) Pub. No.: US 2021/0237316 A1
(43) Pub. Date: Aug. 5, 2021

(54) FIBER PREFORM AND METHOD OF MAKING THE SAME

(71) Applicant: COATS & CLARK, INC., Charlotte, NC (US)

(72) Inventor: Probir Kumar Guha, Bloomfield Hills, MI (US)

(73) Assignee: COATS & CLARK, INC., Charlotte, NC (US)

(21) Appl. No.: 17/164,021

(22) Filed: Feb. 1, 2021

Related U.S. Application Data
(60) Provisional application No. 62/968,422, filed on Jan. 31, 2020.

(51) Int. Cl. B29B 11/16; B29C 65/62; B29C 70/22

(52) U.S. Cl. CPC B29B 11/16; B29K 2309/08; B29C 70/22; B29C 65/62

(57) ABSTRACT

A fiber preform for use in a composite material molding process is provided that includes a fiber bundle containing reinforcing fibers. The fiber bundle arranged in parallel switchbacks forming a first layer of the fiber preform. The parallel switchbacks define a principal orientation. A roving is provided that contains reinforcing fibers in a coating. The roving forms stitches on the fiber bundle in a direction substantially perpendicular to the switchbacks so the stitches join the fiber bundle to itself. A method of forming such a fiber preform includes the fiber bundle in the parallel switchbacks being arranged to form the first layer of the fiber preform. The roving forms stitches on the fiber bundle in a direction perpendicular to the switchbacks to join the fiber bundle to itself.

### RELATED APPLICATIONS

This application claims priority benefit of U.S. Provisional Application Ser. No. 62/968,422 filed Jan. 31, 2020; the contents of which are hereby incorporated by reference.

### FIELD OF THE INVENTION

The present invention in general relates to fiber preforms for use in composite material molding process and a method of construction thereof.

### BACKGROUND OF THE INVENTION

Weight savings in the automotive, transportation, and logistics based industries has been a major focus in order to make more fuel-efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials.

Composite materials are engineered or naturally occurring materials made from two or more constituent materials with significantly different physical or chemical properties which remain separate and distinct at the macroscopic or microscopic scale within the finished structure. There are two categories of constituent materials: matrix and reinforcement. At least one portion of each type is required. The matrix material surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

Commercially produced composites often use a polymer matrix material that is either a thermoplastic or thermoset resin. There are many different polymers available depending upon the starting raw ingredients which may be placed into several broad categories, each with numerous variations. Examples of the most common categories for categorizing polymers include polyester, vinyl ester, epoxy, phenolic, polyimide, polyamide, polypropylene, PEEK, and others.

The use of fiber and particulate inclusions to strengthen a matrix is well known to the art. Well established mechanisms for the strengthening include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM); hereafter referred to collectively as “molding compositions,” fiber strengthening has traditionally involved usage of chopped glass fibers. There is a growing appreciation in the field of molding compositions that replacing in part, or all of the glass fiber in molding compositions with carbon fiber can provide improved component properties.

The use of carbon fibers in composites, sheet molding compositions, and resin transfer molding (RTM) results in formed components with a lower weight as compared to glass fiber reinforced materials. The weight savings achieved with carbon fiber reinforcement stems from the fact that carbon has a lower density than glass and produces stronger and stiffer parts at a given thickness.

Fiber-reinforced composite materials can be divided into two main categories normally referred to as short fiber-reinforced materials and continuous fiber-reinforced materials. Continuous reinforced materials often constitute a layered or laminated structure. The woven and continuous fiber styles are typically available in a variety of forms, being pre-impregnated with the given matrix (resin), dry, uni-directional tapes of various widths, plain weave, harness satins, braided, and stitched. Various methods have been developed to reduce the resin content of the composite material, by increasing the fiber content. Typically, composite materials may have a ratio that ranges from 60% resin and 40% fiber to a composite with 40% resin and 60% fiber content. The strength of a product formed with composites is greatly dependent on the ratio of resin to reinforcement material.

Tailored Fiber Placement (TFP) is a textile manufacturing technique in which fibrous material is arranged on another piece of base material and is fixed with an upper and lower stitching thread on the base material. The fiber material can be placed in curvilinear patterns of a multitude of shapes upon the base material. Layers of the fiber material may be built up to produce a two-dimensional fiber preform insert, which may be used as an insert for a molding process to create composite materials. Unfortunately, due to the tendency of such fiber preforms to be limp in their two-dimensional form, voids or wrinkles are formed when the two-dimensional preform is placed in the typically three-dimensional resin transfer mold. Voids and wrinkles in transfer molded parts significantly reduce strength and modulus of the final composite material, making such fiber preform inserts unfavorable in terms of production cost, increased scrappage, and diminished throughput. Additionally, the level of detail and accuracy required for stitching of such fiber preforms is high resulting in low throughputs and increased manufacturing time and costs.

Thus, there exists a need for fiber preforms with evenly distributed reinforcing fibers that avoid voids and wrinkles in subsequent composite molding processes while being easy and fast to manufacture at a high throughput and a low cost.

### SUMMARY OF THE INVENTION

A fiber preform for use in a composite material molding process is provided that includes a fiber bundle containing reinforcing fibers. The fiber bundle arranged in parallel switchbacks forming a first layer of the fiber preform. The parallel switchbacks define a principal orientation. A roving is provided that contains reinforcing fibers in a coating. The roving forms stitches on the fiber bundle in a direction perpendicular to the switchbacks so the stitches join the fiber bundle to itself.

A method of forming such a fiber preform includes the fiber bundle in the parallel switchbacks being arranged to form the first layer of the fiber preform. The roving forms stitches on the fiber bundle in a direction perpendicular to the switchbacks to join the fiber bundle to itself.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic perspective view of a fiber preform according to embodiments of the present invention;

FIG. 2 is a cross-sectional schematic view of a fiber bundle used in a fiber preform according to embodiments of the present invention;

FIG. 3 a cross-sectional view of a roving used in a fiber preform according to embodiments of the present invention;

FIG. 4 is an exploded perspective view a multi-layered fiber preform according to embodiments of the present invention;

FIG. 5 is a perspective view of the multi-layered fiber preform of FIG. 4;

FIG. 6 is a photograph of a fiber preform according to embodiments of the present invention;

FIG. 7 is a clos-up photograph of the fiber preform of FIG. 6; and

FIGS. 8A-8D are schematic top views of an inventive method for forming a fiber preform according to embodiments of the present invention.

### DETAILED DESCRIPTION OF THE INVENTION

The present invention has utility as a fiber preform for use in a composite material molding process. Embodiments of the present invention provide fiber preforms of virtually any shape and size with selectively distributed reinforcing fibers. Furthermore, the fiber preforms of the present invention may be formed into three dimensional shapes prior to insertion in a mold for forming a composite component, thus, the resulting composite component quality and throughput are enhanced.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, any reference to weight percent or by extension molecular weight of a polymer is based on weight average molecular weight.

As used herein, the term melting as used with respect to thermoplastic fibers or thread is intended to encompass both thermofusion of fibers such that a vestigial core structure of separate fibers is retained, as well as a complete melting of the fibers to obtain a homogenous thermoplastic matrix.

As used herein, the term perpendicular in the context stitching relative to a fiber bundle is defined as 90±16 degrees.

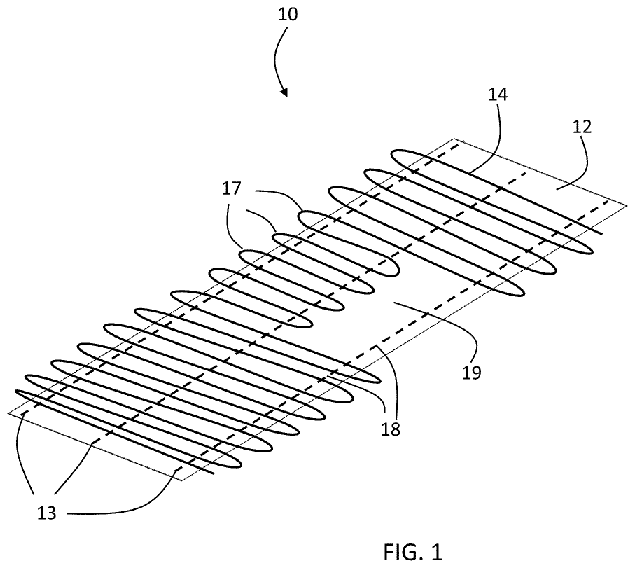

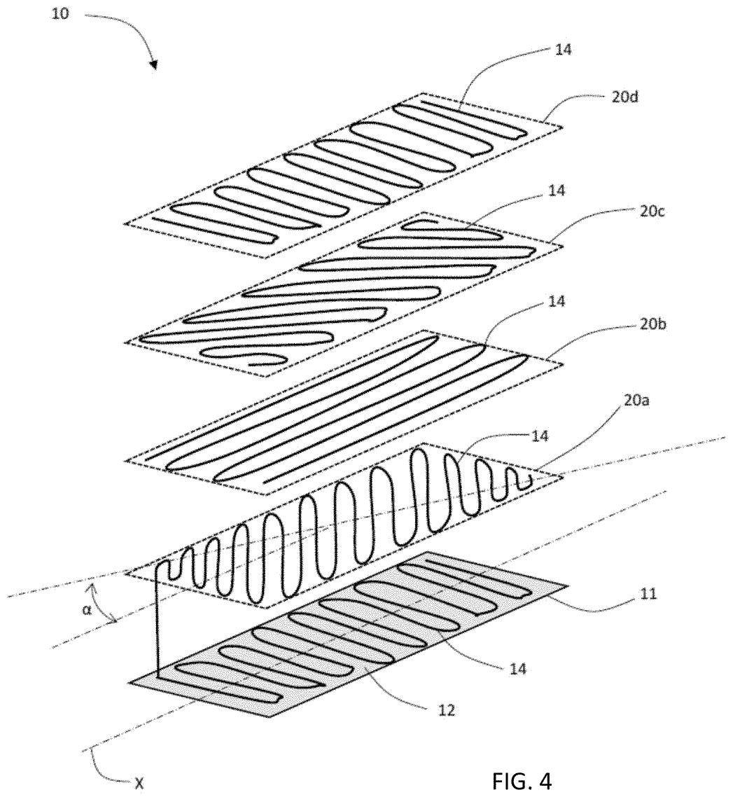

Referring now to FIG. 1, a fiber preform 10 according to one embodiment of the present invention is shown. Embodiments of the fiber preform 10 include a fiber bundle 14 arranged in a plurality of parallel switchbacks 17. The plurality of switchbacks 17 are generally planar and make up a first layer 11 of the fiber preform 10 having a principal orientation along a longitudinal axis X as shown in FIG. 4. The fiber preform 10 additionally includes a roving 13 that forms a plurality of stitches 18 on the fiber bundle 14 to join the fiber bundle 14 to itself. The plurality of stitches 18 are formed in a direction that is perpendicular to the direction of the plurality of switchbacks 17. Additionally, as shown in FIG. 1, the fiber preform 10 optionally includes a substrate 12 which may be used as a foundation or base upon which the fiber bundle 14 is applied and arranged. The substrate 12 may be a fabric or paper or other suitable material. When a substrate 12 is used, the substrate 12 may be removable after formation of the fiber preform 10 and before the fiber preform 10 is used in a composite material molding process. Stitching is readily formed from aramid fibers, thermoplastic fibers, carbon fibers, each alone or in combination.

The fiber bundle 14 is made of comingled reinforcing fibers, such as those made of carbon, glass, aramid fibers, basalt fiber, or any combination thereof and optionally thermoplastic fibers which serve to provide a matrix in a composite material made of both reinforcing and matrix fibers. The fibers can also have functional uses that include conductive fiber, and optical fiber. The optional matrix fibers, being of a thermofusible nature may be formed from a thermoplastic material such as, for example, polypropylenes, polyamides, polyesters, polyether ether ketones, polybenzobisoxazoles, polyphenylene sulfide; block copolymers containing at least of one of the aforementioned constituting at least 40 percent by weight of the copolymer; and blends thereof. The thermoplastic fibers are appreciated to be recycled, virgin, or a blend thereof. The thermofusible thermoplastic matrix fibers have a first melting temperature at which point the solid thermoplastic material melts to a liquid state. The reinforcing fibers may also be of a material that is thermofusible provided the thermofusion of the reinforcing fibers occurs at a temperature which is higher than the first melting temperature of the matrix fibers so that, when both fibers are used to create a composite, at the first melting temperature at which thermofusibility of the matrix fibers occurs, the state of the reinforcing fibers is unaffected. The thermoplastic fibers are appreciated to be recycled, virgin, or a blend thereof. According to embodiments, any thermoplastic fibers in the fiber bundle 14 constitute from 20 to 80 weight percent of the comingled fibers in the present invention.

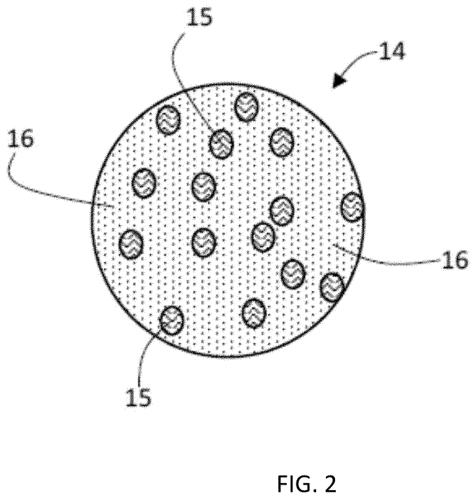

As shown in cross-section in FIG. 2, the fiber bundle 14 may include a subset of comingled fiber bundle fibers 15, a subset of roving fibers 16, or a combination thereof. The comingled fiber bundle fibers 15 are helical or spun, while the roving fibers 16 are parallel to one another and not helical. The fiber bundle 14 may be a single continuous fiber bundle fed from a spool in the process of forming the fiber preform 10. Alternatively, the fiber preform 10 may be formed of multiple separate fiber bundles. Using multiple fiber bundles to form the fiber preform allows for fiber bundles having different thermoplastic fibers and reinforcing fibers, which enables tuning of the fiber preform insert. Additionally, increasing the number of fiber bundles used in the formation process speeds the fiber preform manufacturing process, which increases throughput and efficiency. The multiple fiber bundles may be applied to together starting from the same end of or the multiple fiber bundles may be applied spaced apart with each fiber bundle beginning at opposite ends and converging at a middle region between the ends of the fiber preform. According to embodiments of the present invention, the fiber bundle 14 includes entirely reinforcing fibers and not thermoplastic fiber. Alternatively, the comingled fiber bundle includes both reinforcing fibers and thermoplastic fibers. As described throughout the present disclosure, the reinforcing fibers include carbon fiber, glass fiber, aramid fibers, or a combination thereof.

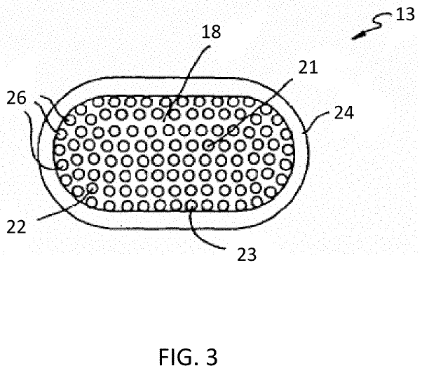

As shown in FIG. 3, the roving 13 includes a bundle of fibers 22 in a coating 24. The bundle of fibers 22 is comprised of a plurality of inner fibers 21 and a plurality of outer fibers 23 held together by a sizing composition 28. Preferably, the sizing composition is a high integrity sizing composition comprising approximately 0.5 to 5% by weight of the total weight of the bundle of fibers 22. In addition, the bundle 22 contains between approximately 500 and 1100 filaments of inner fibers 21 and outer fibers 23 comprised of filaments that are approximately 8-16 microns in diameter. Coating material 24, which according to embodiments is a powder coating polymer, is introduced to the outer surfaces 26 of the outer fibers 23 such that the coating material substantially surrounds the bundle 22. Of course, some of the coating material 24 enters within the bundle 22 during the formation of the roving 13. According to embodiments, the coating material 24 is approximately 10-80% of the weight of the multiend composite roving 13 weight. The coating material 24, when in a powder form is approximately 1-100 microns in diameter, with preferred ranges equaling 5-10 microns in diameter.

According to embodiments, the sizing composition 28 is approximately 1% by weight of the total weight of the bundle 22 of fibers and the fiber bundle 22 is approximately 12 microns in diameter and contains approximately 800 individual filament fibers 21, 23. Also, the coating material 24 preferably comprises approximately 20-30% of the weight of the composite roving 13.

The fibers 21, 23 in the bundle of fiber 22 of the roving 13 are reinforcing fibers. These reinforcing fibers are thermally stable at the temperatures involved in the formation of composite materials. These fibers 21, 23 that are used may thus be of many different types, including glass fibers, carbon and graphite fibers, organic fibers, aramid fibers, natural fibers, synthetic fibers, hybrid fibers and combinations thereof that are well known in the art. Preferably, e-type glass, s-type glass, or carbon fibers are used as the reinforcing material.

The sizing composition 28 maintains the individual fibers 21, 23 in a bundle 22 during processing. It therefore is not easy to filamentize the bundle 22 during processing. A low integrity sizing composition, by contrast, allows the bundle strands to easily filamentize. The cross-section of the roving may be elliptical, round, or irregularly shaped.

The coating 24 is a polymer coating, which may be applied to the fiber bundle 22 as a slurry or emulsion coating having a powdered polymer material. The powdered polymer material is a good wetting matrix resin that is capable of being applied as a dip coating at room temperature. According to embodiments, the coating material 24 is capable of melting, flowing, and curing when it is molded into a final composite part. Many different coating materials may be used, including polyesters, bisphenol type epoxies, novalac type epoxies, phenolics, acrylics, polyurethanes, hybrid polymers (for example, an epoxy polyester copolymer or a polyester triglycidylisocyanurate copolymer) and other thermoplastic or thermosetting polymers that exhibit good wetting and processability for making a structural composite part. In addition, the coating 24 may contain film formers that aid in attaching the coating material to the bundles 22. For example, polyurethanes may be used as film formers. Also, the coating 24 may also contain additives that aid in dispersing the coating material in the film former and water and in thickening the slurry to a desired thickness.

According to embodiments, the fiber bundle 14 is arranged on a planar surface, such as a substrate 12 by guiding the fiber bundle 14 and arranging the finer bundle 14 in such a way as to form the plurality of switchbacks 17. As shown in FIG. 1, the switchbacks 17 may be closely spaced together or may be spaced further apart. Additionally, the fiber bundle 14 may be arranged such that the fiber preform 10 includes an area 19 that is void of the fiber bundle 14. The arrangement of the fiber bundle 14 on the planar surface or the optional substrate 12 may generally resemble the shape of the designed final composite material component, for example a structural component of an automobile. The fiber bundle 14 may be arranged in a principal direction, for example in a principal direction of stress of the final composite material component. In FIG. 4, the principal orientation of the fiber bundle 14 is along a longitudinal axis X of the fiber preform 10, however, other suitable orientations are also possible and may be used based on the design considerations and stresses for each composite material part. Substrates operative in the present invention include thermoplastic fabrics, glass fiber fabrics, carbon fiber fabrics, and combinations thereof.

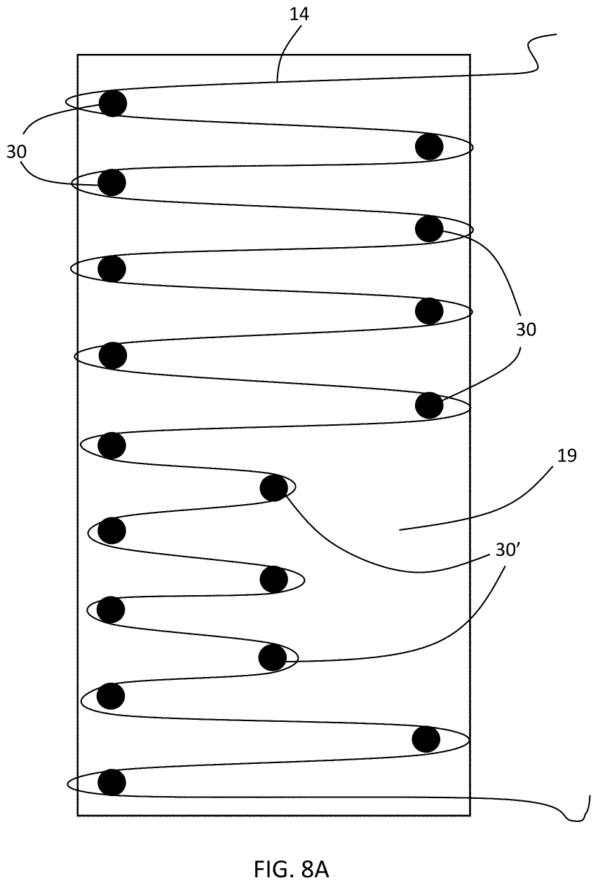

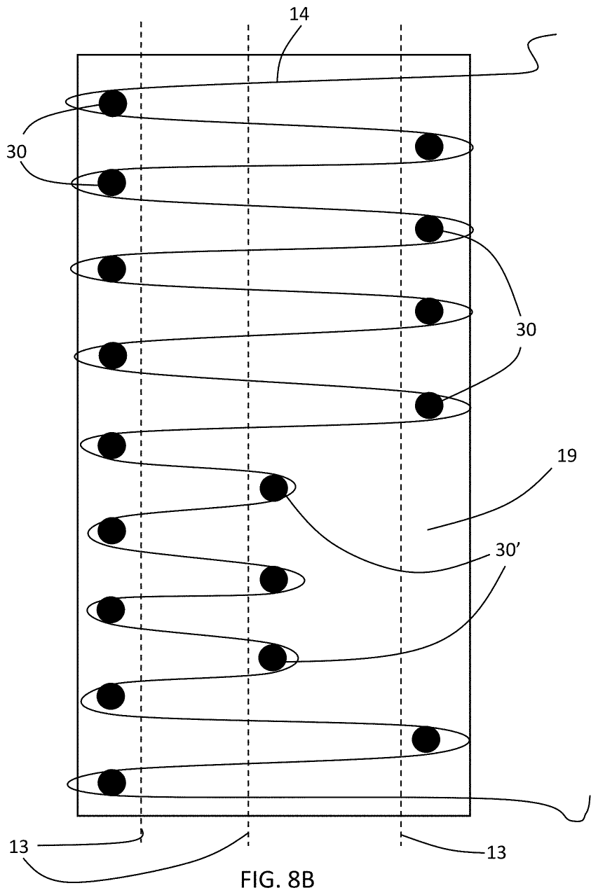

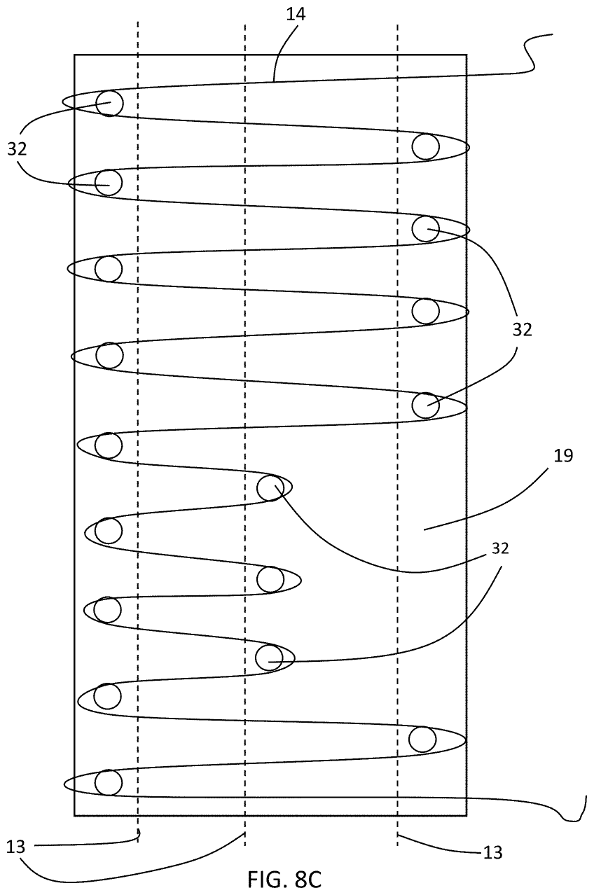

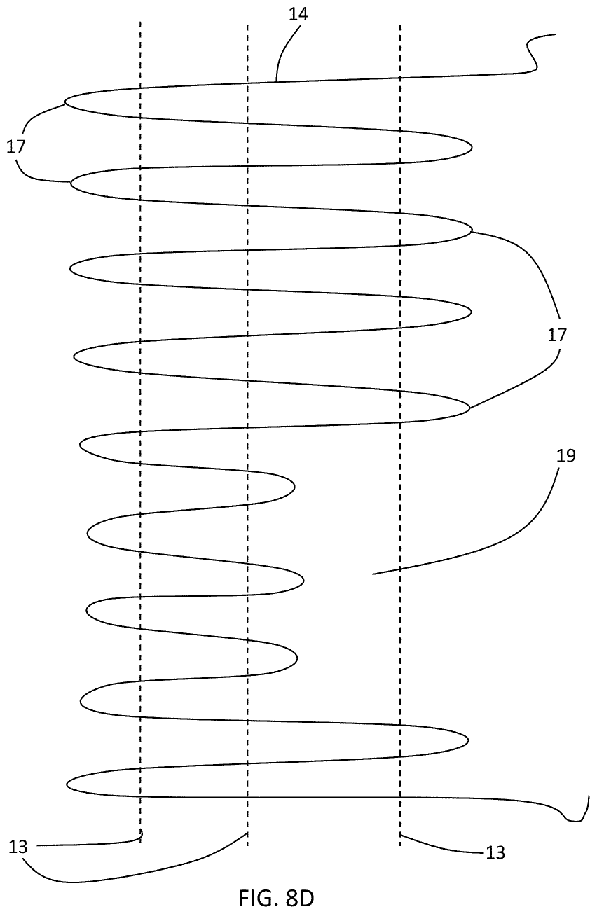

According to embodiments, such as that shown in FIG. 8A, the fiber bundle 14 is arranged in the plurality of parallel switchbacks 17 by guiding the fiber bundle 14 back and forth and looping the fiber bundle 14 on a plurality of pegs 30. The pegs 30 may be positioned at any point where it is desired for the fiber bundle 14 to be looped. As shown in FIG. 8A, pegs 30′ are placed such that when the fiber bundler 14 is arranged an area 19 that is void of the fiber bundle 14 is formed. As shown in FIG. 8B, the roving is then stitched to the fiber bundle 14 to join the fiber bundle 12 to itself and/or to a substrate 12, when present. The roving stitches 18 are formed in a direction perpendicular to the plurality of switchbacks 17. As shown in FIG. 8B, the roving 13 is stitched to the fiber bundle 14 near the location of the pegs 30. The stitching may take place while the fiber bundler 14 is still looped around the pegs 30 so that the fiber bundler 14 is held in the switchback arrangement. According to embodiments, as shown in FIG. 8C, the pegs 30 are removable or retractable from preformed holes 32 to facilitate easy removal of the formed fiber preform 10. Finally, as shown in FIG. 8D, the fiber preform 10 is formed and ready for use in a composite material molding process with a conventional sheet molding composition (SMC) or bulk molding composition (BMC). According to embodiments of the present invention, an inventive preform is suitable to use with any known composite component processing technique, such as RTM, LCM, thermoplastic overmolding, injection molding, and the like.

The fiber preform 10 is tunable and easily changed and adapted for varying design requirements. The properties and characteristics of the fiber preform may be changed and modified based on controlling parameters of the various components of the fiber preform including parameters of the fiber bundle 14, the roving 13, and the plurality of stitches 18. Parameters of the fiber bundle may include, but are not limited to, a diameter of the fiber bundle, a ratio of the thermoplastic fibers to the reinforcing fibers, a composition of any thermoplastic fibers, and a composition of the reinforcing fibers. Parameters of the roving may include, but are not limited to, a denier of the roving and the composition of the fibers therein. The parameters of the plurality of stitches 18 of the roving 13 may include, but are not limited to, a linear distance between the stitches and a tension of the stitches.

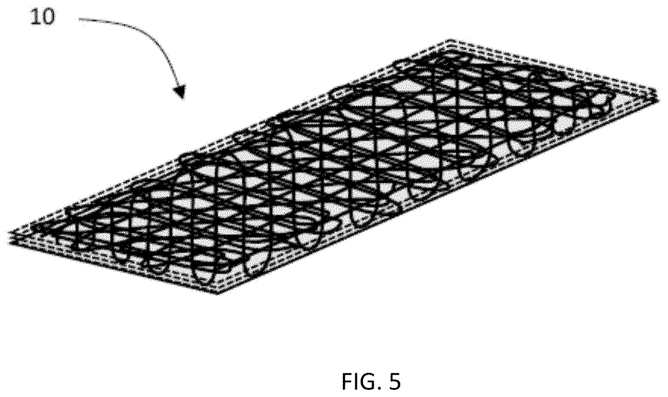

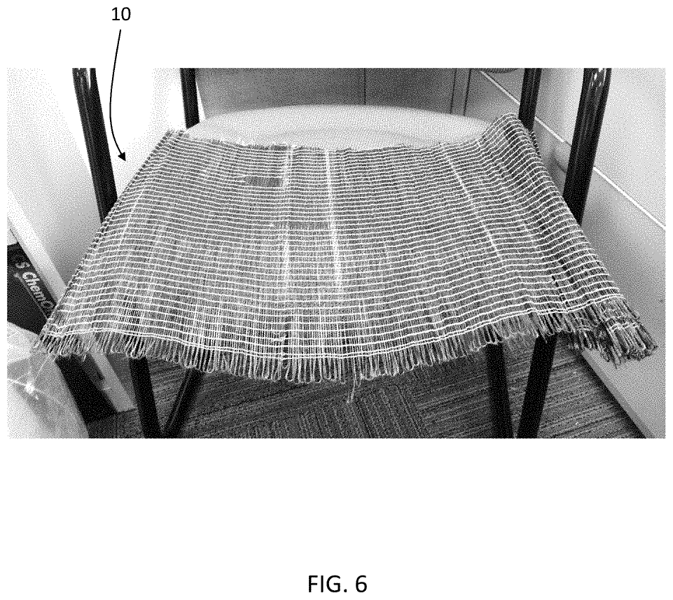

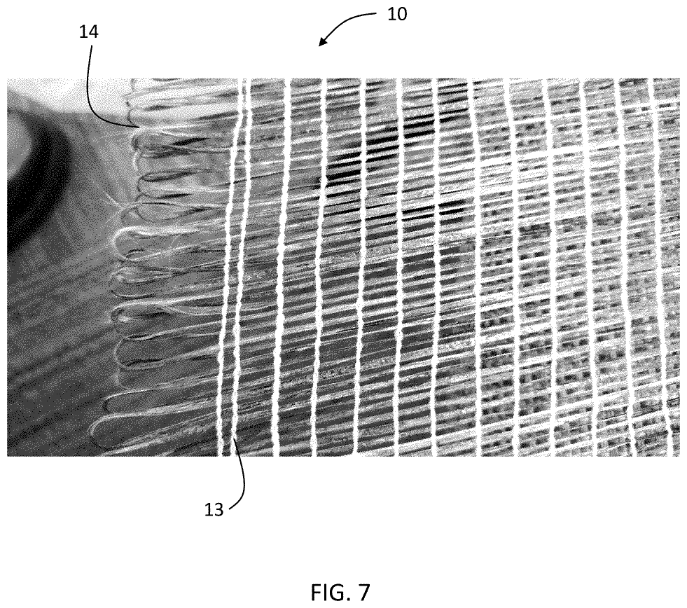

Referring now to FIGS. 4 and 5, a multi-layered fiber preform 10 according embodiments of the present invention includes the first preform layer 11 with its principal orientation along the X axis and a plurality of subsequent preform layers 20a, 20b, 20c, 20d formed of the fiber bundle 14 successively stacked from the first preform layer 11. Each subsequent preform layer 20a, 20b, 20c, 20d is arranged on a preceding preform layer and attached to the preceding preform layer by additional stitches of the roving. For example, the first subsequent preform layer 20a is arranged on and attached to the preceding first preform layer 11, the second subsequent preform layer 20b is arranged on and attached to the preceding first subsequent preform layer 20a, the third subsequent preform layer 20c is arranged on and attached to the preceding second subsequent preform layer 20b, and the fourth subsequent preform layer 20d is arranged on and attached to the third subsequent preform layer 20c. While the example fiber preform 10 shown in FIGS. 4 and 5 include four subsequent preform layers for a total of five preform layers including the first preform layer, it is appreciated that the plurality of subsequent preform layers may include two to twenty layers. The fiber bundle 14 that forms each of the subsequent preform layers may be a continuation of the fiber bundle of the preceding preform layer or it could be a separate piece of fiber bundle.

In FIGS. 4 and 5, the plurality of stitches of the roving 13 are not shown for the sake of clarity, but it will be readily understood that each layer of fiber bundle 14 is attached to the preceding layer and/or to itself by a plurality of stitches identical to those explained throughout the present disclosure. It is appreciated that the stitches used to secure each subsequent preform layer could extend to a substrate if present. Alternatively, the stitches used to attach each subsequent preform layer can extend to the preceding preform layer, which allows for a more efficient preform manufacturing process in that the penetration depth of the stitching needle need not be altered between the various layers of fiber bundle. After at least one of the subsequent preform layers has been stacked and attached to the first preform layer, the substrate, if present, may be removed from the fiber preform. Alternatively, a substrate may remain attached to the first preform layer until all of the subsequent preform layers have been stacked on and attached to the preceding preform layer, or the substrate can remain attached to the fiber preform throughout the composite material manufacturing process.

As shown in FIG. 4, the orientation of each subsequent preform layer may be offset from the orientation of the preceding preform layer. Offsetting the orientation of the various layers enables strength in multiple directions. The orientation of each subsequent preform layer may be offset from that of the preceding preform layer by an angular displacement a relative to the principal orientation of the first layer, for example the X axis. The layers can be overlaid with a variety of angular displacements relative to a first layer. If zero degrees is defined as the long axis X of the first preform layer 11, the subsequent preform layers are overlaid at angles of 0-90°. For example, in the fiber preform 20 shown in FIG. 4, the angular displacement a is 45° resulting in a 0-45-90-45-0 pattern of preform layers. Further specific patterns illustratively include 0-45-90-45-0, 0-45-60-60-45-0, 0-0-45-60-45-0-0, 0-15-30-45-60-45-30-15-0, and 0-90-45-45-60-60-45-45-90-0. While these exemplary patterns are for from 5 to 10 layers of uni-directional fibers, it is appreciated that the fiber preform may include from 3 to 20 layers. It is appreciated that the preform layers may be symmetrical about a central layer, in the case of an odd number of layers, or about a central latitudinal plane parallel to the players. That is, as shown in FIG. 4, the orientation of the first layer 11 and the last of the subsequent preform layers 20d are generally the same while the first subsequent layer 20a and third subsequent preform layer 20c are symmetrical with one another, such that the layers 11, 20a, 20c, and 20d are symmetrical about the center layer 20b. Providing the various preform layers with symmetrical orientations enables the fiber preform 10 to resist warping.

The foregoing description is illustrative of particular embodiments of the invention but is not meant to be a limitation upon the practice thereof. The following claims, including all equivalents thereof, are intended to define the scope of the invention.

1. A fiber preform for use in a composite material molding process, the fiber preform comprising:
a fiber bundle comprising reinforcing fibers, the fiber bundle arranged in a plurality of parallel switchbacks forming a first layer of the fiber preform having a principal orientation; and
a roving comprising reinforcing fibers in a coating, the roving forming a plurality of stitches on the fiber bundle in a direction perpendicular to the plurality of switchbacks, the plurality of stitches joining the fiber bundle to itself.

2. The fiber preform of claim 1 further comprising a plurality of subsequent preform layers formed of the fiber bundle and successively stacked from the first preform layer, each subsequent preform layer arranged on a preceding preform layer and attached to the preceding preform layer by additional stitches of the roving.

3. The fiber preform of claim 2 wherein an orientation of each subsequent preform layer is offset from that of the preceding preform layer by an angular displacement relative to the principal orientation of the first layer.

4. The fiber preform of claim 3 wherein the angular displacement between each of the preform layers is any one of 15 degrees, 30 degrees, 45 degrees, 60 degrees, 75 degrees, and 90 degrees.

5. The fiber preform of claim 1 wherein the reinforcing fibers of the fiber bundle are glass fibers, aramid fibers, carbon fibers, or a combination thereof.

6. The fiber preform of claim 1 wherein the fiber bundle further comprises thermoplastic fibers.

7. The fiber preform of claim 1 wherein the fiber bundle includes a subset of yarn fibers, a subset of roving fibers, or a combination thereof.

8. The fiber preform of claim 1 wherein the fiber preform is formed of a single continuous fiber bundle.

9. The fiber preform of claim 1 wherein the fiber preform is formed of at least two separate fiber bundles.

10. The fiber preform of claim 1 wherein the reinforcing fibers of the roving are glass fibers, aramid fibers, carbon fibers, or a combination thereof.

11. The fiber preform of claim 1 wherein the reinforcing fibers of the roving are sized with a sizing composition that maintains the fibers in the roving.

12. The fiber preform of claim 1 wherein the coating of the roving is a polymer coating.

13. The fiber preform of claim 1 wherein the coating of the roving is a thermoset resin coating.

14. The fiber preform of claim 1 wherein the coating of the roving surrounds the reinforcing fibers of the roving.

15. The fiber preform of claim 1 further comprising a substrate on which the fiber bundle is arranged.

16. A method of forming a fiber preform of claim 1, the method comprising:
arranging the fiber bundle in the plurality of parallel switchbacks to form the first layer of the fiber preform; and
stitching with the roving to form the plurality of stitches on the fiber bundle in a direction perpendicular to the plurality of switchbacks, the plurality of stitches joining the fiber bundle to itself.

17. The method of claim 16 wherein arranging the fiber bundle includes looping the fiber bundle on a plurality of pegs.

18. The method of claim 17 wherein the pegs are removable.

19. The method of claim 16 further comprising stitching each of the subsequent layers to a preceding layer using the roving.

20. The method of claim 19 wherein each of the subsequent layers of the fiber bundle is offset from the preceding layer by an angular displacement relative to the principal orientation of the first layer.
